(19) United States
(12) Patent Application Publication
(10) Pub. No.: US 2002/0054613 A1
(43) Pub. Date: May 9, 2002

(54) Compact, highly efficient and rugged UV source based on fiber laser

(76) Inventor: Jin U. Kang, Ellicott City, MD (US)

Correspondence Address: McGuire Woods, LLP, Suite 1800, 1750 Tysons Boulevard, McLean, VA, 22102-3915, US

(21) Appl. No.: 09/970,903

(22) Filed: Oct. 5, 2001

Related U.S. Application Data
(60) Provisional application No. 60/238,050, filed on Oct. 6, 2000.

(51) Int. Cl. H01S 3/30; H01S 3/10

(52) U.S. Cl. 372/6; 372/22

(57) ABSTRACT

A tunable highly efficient and high power ultraviolet (UV) laser source with good spatial beam quality is disclosed. A plurality of laser lights are generated by ytterbium (Yb) doped fiber laser and erbium/ytterbium (Er/Yb) doped fiber laser. In order to achieve a desired UV wavelength, the Yb-doped and Er/Yb-doped fiber lasers are tuned to generate laser lights of certain wavelengths based on a desired UV light wavelength. The laser lights from the Er/Yb-doped fiber laser and the Yb-doped fiber laser are frequency-doubled. The frequency-doubled laser lights are non-linearly frequency-mixed to generate a UV light with the desired wavelength.

### CROSS REFERENCE TO RELATED APPLICATION

This application claims priority to U.S. Provisional Application Serial No. 60/238,050 filed on Oct. 6, 2000, hereby fully incorporated by reference herein.

### BACKGROUND OF THE INVENTION

1. Field of the Invention

The present invention generally relates to fiber lasers and, more particularly, to generating high efficient and high power UV (ultraviolet) light beam based on Yb-doped and Er/Yb-doped fiber lasers.

2. Background Description

There is a great interest and need for developing compact, reliable high power ultra-violet (UV) light sources for many types of applications, such as, spectroscopy, environmental monitoring, gas and chemical sensing, particularly of the upper atmosphere, and manufacturing process control. The most serious limitations to practical UV sources have been the efficiency, complexity, cost, stability and reliability in implementing UV light equipment. For example, conventional flash lamp-pumped or diode-pumped solid-state or gas lasers can be inefficient in terms of power conversion, bulky and very vulnerable to shock and vibration, which requires constant alignment. Also, the flash lamp-pumped or diode-pumped Nd:YAG lasers requires frequent replacement of the flash lamp or diode lasers and requires high maintenance cost. For example, 808 (nm wavelength) diode pumps for the diode-pumped Nd:YAG lasers must be replaced annually (since, to obtain such a wavelength, they generally contain aluminum which shortens their useful lifetime), and flash lamps last only about 1000 hours. Also, once installed in a system, flash lamp-pumped or diode-pumped Nd:YAG lasers can not be easily tuned to generate a desired UV light output wavelength for various applications.

Accordingly, the flash lamp-pumped or diode-pumped Nd: YAG laser based UV systems may not be suitable for satellite-based sensors, for example, for measuring ozone layer density or concentration of various gases, e.g., SO₂ or CO₂, etc., in severe conditions (e.g., space shuttles and other airborne applications and many manufacturing processes). Furthermore, the Nd: YAG based systems do not provide desired UV wavelength easily.

So-called fiber lasers are known which use a length of doped optical fiber as the lasing cavity and thus provide some advantages over other types of lasers such as excimer, semiconductor diode and solid state lasers. Specifically, fiber lasers are compact, light weight, rugged, inexpensive, of high power, gain and efficiency and generally exhibit low amplified spontaneous emission noise, good stability and narrow linewidth while being broadly tunable. Fiber lasers can also be pumped with 980 nm laser diodes which exhibit a long lifetime; allowing very low levels of required maintenance. However, known fiber lasers generally provide only relatively low output power and can be highly non-linear due to the small core diameter. Therefore, despite some potential advantages, fiber lasers have been considered unsuitable for many applications requiring high power UV wavelengths and good spatial quality of the beam. However, with the development of large core and high power fiber amplifiers, the fiber laser as amplifiers are becoming a suitable source for the high power UV systems.

### SUMMARY OF THE INVENTION

It is therefore an objective of the present invention is to generate one or more ultraviolet (UV) lights having desired UV light wavelengths.

Another object of the present invention is to generate one or more highly efficient and high power UV light with a good spatial beam quality.

Further, an object of the present invention is to provide a rugged, durable, low-maintenance and cost-effective laser beam equipment which is suitable for severe operation conditions.

According to the present invention, the foregoing and other objects are achieved in part by an ultraviolet (UV) light generator which includes a plurality of fiber lasers. Each fiber laser generates a laser light having a wavelength predetermined based on a desired UV light wavelength. A frequency-doubling unit is provided to generate second or higher harmonic lights of the laser lights. A non-linear frequency mixer is provided for combining wavelengths of the second harmonic lights to generate a UV light with the desired UV light wavelength.

The foregoing and other objects are also achieved in part by a method for generating a ultraviolet (UV) light. A plurality of laser lights are generated by using fiber lasers. A wavelength of each laser light is predetermined based on a desired UV light wavelength. The laser lights are frequency-doubled to generate a plurality of second harmonic lights. The second harmonic lights are non-linear frequency-mixed and focused on a crystal to generate a UV light having the desired UV light wavelength.

Additional objects, aspects and advantages of the present invention will become readily apparent to those skilled in this art from the following detailed description. As will be realized, the present invention is capable of other and different embodiments and its several details are capable of modifications in various obvious respects, all without departing from the present invention. Accordingly, the drawings and description are to be regarded as illustrative in nature, and not restrictive.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a block diagram of a tunable ultraviolet (UV) laser beam generator according to an embodiment of the present invention.

FIG. 2 depicts a block diagram of another UV laser beam generator according another embodiment of the present invention.

### DETAILED DESCRIPTION OF A PREFERRED EMBODIMENT OF THE INVENTION

The present invention provides a tunable ultraviolet (UV) light system for generating one or more highly efficient and high power UV lights, which is rugged, durable and cost-effective for the use in severe operation conditions, e.g., space shuttle, etc. Particularly, the UV light system according to the present invention is tunable and therefore capable of generating UV lights with desired wavelengths for various applications. This is achieved by using a number of fiber lasers to generate a plurality of laser lights having predetermined wavelengths. These laser lights can be frequency-multiplied (e.g. doubled) and non-linear frequency-mixed using linear and/or non-linear optical elements to generate a UV light with a desired wavelength. Thus, the wavelengths of the laser light from the fiber lasers can be determined over a relatively wide range and are tunable depending on the desired wavelength of the UV light output. Also, either by selectively non-linear frequency-mixing each one of the frequency-doubled laser lights with another frequency-doubled laser light, or by further frequency-doubling the wavelength-tunable laser lights, the wavelength of the UV light output can be coarsely selected and fine-tuned as desired.

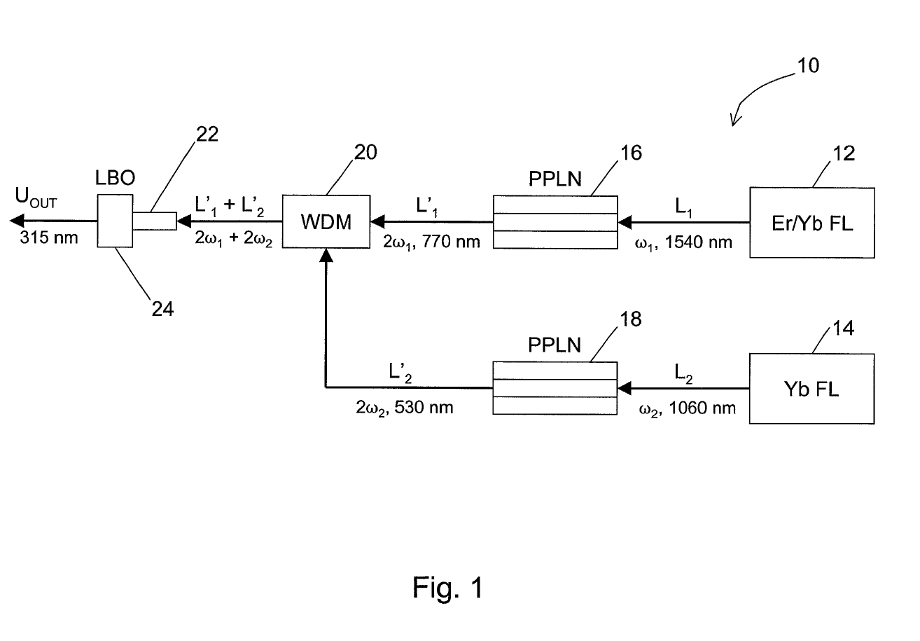

With this idea in mind, referring now to the drawings, and more particularly to FIG. 1, there is shown a tunable, highly efficient and high power UV light generator 10 according to the present invention. The UV light generator 10 uses at least two fiber lasers to generate a number of laser lights. There is possibility that fiber lasers can be unsuitable due to the non-linear effects. To decrease the non-linear effects and damage, fiber lasers having a large core diameter are preferred to decrease the intensity inside the fiber. Furthermore, a combination of a lower power fiber laser and a high power fiber laser can be more suitable for the very high power application. Fiber lasers are commercially available and have several advantages over conventional flash lamp-pumped or diode-pumped solid state lasers.

Fiber lasers are more efficient as compared to Nd:YAG (neodymium: yttrium aluminum garnet) lasers. For example, Yb-doped fiber lasers require only 1/100 of the electrical power of a flash lamp-pumped Nd: YAG laser. Also, fiber lasers are more efficient than diode-pumped Nd: YAG lasers. Also, Fiber lasers are rugged and of light weight since a typical diameter of an optical fiber is only about 1 mm and the density is same as that of the glass. Fiber lasers are durable enough not to break easily or stop working even in severe conditions without occupying excessive space, and do not necessitate alignment to compensate the differentiation caused by vibration or shocks. Therefore, fiber lasers are more suitable for flight platforms (e.g., space shuttles, which are highly subject to vibrations and shocks) than bulk optic-based lasers which may require constant alignments to compensate for alterations due to vibrations and shocks. Fiber lasers are durable and stable, and virtually maintenance free. The fiber laser uses longlasting and highly stable 980 diode pumps, which are semiconductor lasers generating a laser beam having a wavelength of 980 nm. The lifetimes of 980 diode pumps are typically well over 100,000 hours. Therefore, there is almost no need for replacement parts and services. In this regard, diode-pumped Nd: YAG lasers typically require annual replacement of 808 diode pumps, which are semiconductor lasers generating a laser beam having a wavelength of 808 nm. The typical 808 diodes contain aluminum to obtain the specific wavelength, which also considerably shortens the lifetime of the laser. Similarly, flash lamp-pumped Nd: YAG lasers require flash lamp replacement every 1000 hours or so.

Further, more fiber lasers are tunable. For example, ytterbium-doped fiber lasers and erbium/ytterbium-doped fiber lasers have the broad gain bandwidths over about 70 nm and 50 nm, respectively, and thus can be continuously tuned from about 1030 nm to about 1100 nm microns and 1530 nm to 1580 nm, respectively, if necessary. In addition, a single mode fiber output insures a good beam quality and high nonlinear conversion efficiencies. Even compared with frequency doubled, tripled, or mixed diode lasers, the fiber approach is the best option to date since high power, wide band gap diode lasers have not been developed and even the near IR single mode diode lasers rarely exceed average power of 200 mW. Although some high power diode lasers are known, they are multi-mode and cannot be used practically. Furthermore, some of the diode lasers below 900 nm are short lived and require costly replacement every year.

According to an embodiment of the present invention, as shown in FIG. 1, there are shown an erbium/ytterbium (Er/Yb)-doped fiber laser 12 and an ytterbium (Yb)-doped fiber laser 14, which generate laser lights L₁ and L₂ having frequencies ω₁ and ω₂, respectively. The wavelengths of the laser lights L₁ and L₂ are selectively predetermined such that the UV light generator 10 generates a UV light output having a desired wavelength. Preferably, the fiber lasers 12 and 14 are configured as Q-switched by adding a intensity modulator inside the cavity. Typically, the wavelength of the laser light L₁ by the Er/Yb-doped fiber laser 12 can be selected within the range between about 1530 nm and about 1580 nm, and the wavelength of the laser light L₂ by the Yb-doped fiber laser 14 can be selected within the range between about 1030 nm and 1100 nm. FIG. 1 particularly shows the Q-switched fiber lasers 12 and 14 tuned to generate the laser lights L₁ and L₂ having the wavelengths of 1540 nm and 1060 nm, respectively.

The laser lights generated by the fiber lasers 12 and 14 are frequency-doubled by a frequency-doubling unit, for example, a group of second-order non-linear crystals, preferably, a group of periodically poled LiNbO₂ (PPLN) waveguides. As shown in FIG. 1, integrated fiber pigtailed PPLN waveguides 16 and 18 are preferred because the fiber coupling of PPLN eliminates the need for alignment and allows low insertion loss. Also, high peak intensity and long linear interaction length allow high conversion efficiency. By using no-depletion approximation, the intensity of the second harmonic generated by each PPLN waveguide could be calculated by the following equation:

$${I}_{2 ω} ( L , {I}_{ω} ) = \frac{2 {ω}^{2}}{{n}_{ω}^{2} {n}_{2 ω} {ϵ}_{0} {c}^{3}} {d}_{eff}^{2} {L}^{2} {I}_{ω}^{2} sin {c}^{2} ( \frac{Δ kL}{2} )$$

Here, I_{2ω} and I₂ are the intensity of the second harmonic and fundamental wavelength, respectively, n is the reflective index, c is the speed of light, d_{eff} is the effective second order coefficient which is approximately 20 pm/V for PPLN, L is the length of PPLN, and Δk is the phase-mismatching term. For example, for a 4 cm long PPLN device, considering a mode overlap between the fundamental and second harmonics and the phase matching band PPLN, a conversion efficiency of over 10% W maybe achieved. Even in the case of bulk PPLN, a conversion efficiency of 8.5% W has been recently reported with a single-pass continuous wave conversion efficiency of 42%. Also, a preliminary numerical study indicates that more than 80% of the fundamental light is converted into a second harmonic light. Because of the high peak power available from the fiber laser, even with the bulk second harmonic crystal, very high conversion efficiency may be achieved. However, since the fiber approach eliminates the need for bulk lens and components, a compact and stable system can be achieved.

FIG. 1 further shows the second harmonic lights L′₁, and L′₂ generated from the PPLN waveguides 16 and 18 having doubled frequencies 2ω₁ and 2ω₂ and wavelengths 770 nm and 530 nm, respectively. These second harmonic lights L′₁, and L′₂ are combined by a non-linear frequency-mixing unit, for example, wavelength division multiplexing (WDM) coupler 20, and focused on a bulk lithium triborate (LBO) crystal 24 by using a graded index (GRIN) lens 22 for a non-linear sum frequency-mixing to generate a UV light output Uₒᵤₜ with a desired wavelength. By non-linear sum frequency mixing the second harmonic lights L′₁ and L′₂ having the wavelengths of 770 nm and 530 nm, a UV light output Uₒᵤₜ having a wavelength of 315 nm is achieved. Thus, according to the present invention, a UV light with a desired wavelength is achieved by utilizing the fiber lasers to generate a number of laser lights with specific wavelengths. The non-liner sum frequency power could be calculated by the following equation:

$${P}_{ω1 + ω2} = \frac{8 {ω}_{0}^{2} {k}_{0} {d}_{eff}^{2}}{{πϵ}_{0} {n}_{1} {n}_{2} {n}_{3} {c}^{3}} h ( B , ξ ) ( 1 - {γ}^{2} ) {LP}_{1} {P}_{2}$$

Where, P is the powers in Watt, h is the function of beam divergence and is approximately 0.12, ω₀=(ω₁+ω₂ )/2, K₀=(K₁+K₂)/2, and γ=(1−ω₁/ω₀). Based on this equation, the sum frequency power to be approximately 0.16 mW/W²P₁P₂. Thus, for input powers of approximately 10 kW, it is expected to obtain a peak sum frequency power of 16 kW or approximately 80% conversion efficiency. Based on these predicted conversion efficiencies, and assuming a non-linear conversion efficiency of 80% for both the second harmonic generation and the sum frequency mixing, and the average wall-plug efficiency of 20% for the fiber lasers, a wall-plug efficiency of up to 13% is expected for the UV light system of FIG. 1 according to the present invention. This system allows the tuning of UV output wavelengths between about 307 nm and about 325 nm, simple frequency triplet and quadruplet can produce other wavelengths around 354 nm, 266 nm and 384nm.

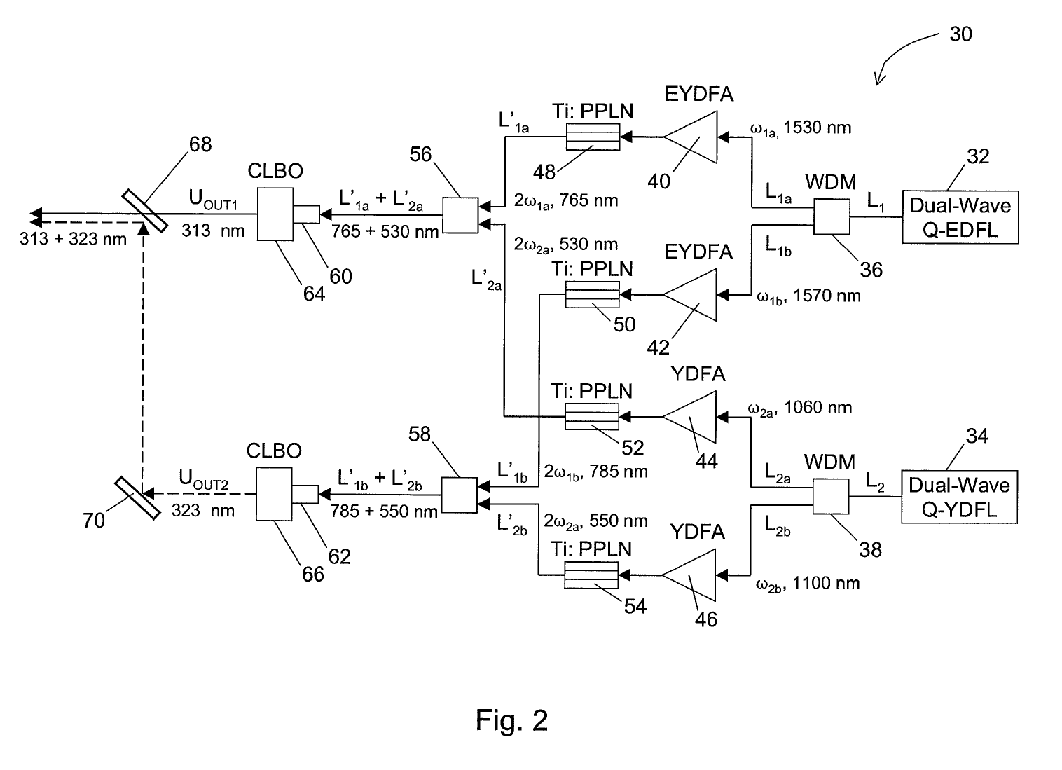

FIG. 2 depicts another UV light generating system 30 according to the second embodiment of the present invention. The UV light generating system 30 includes a dual-wave Q-switched erbium/ytterbium-doped fiber laser (Q-EDFL) 32 and a dual-wave Q-switched ytterbium-doped fiber laser (Q-YDFL) 34, which generates laser lights L₁ and L₂, respectively. The laser light L₁ is split by the first wavelength division multiplexing (WDM) splitter 36 to generate two laser lights L₁ₐ, L_{1b} having frequencies ω₁ₐ, ω_{1b} and wavelengths 1530 nm, 1570 nm, respectively. In the same way, the laser light L₂ is split by the second WDM splitter 38 to generate two laser lights L₂ₐ, L_{2b} having frequencies ω₂ₐ, ω_{2b} and wavelengths 1060 nm, 1100 nm, respectively. As previously mentioned, the wavelengths of the laser lights L₁ₐ, L_{1b}, L₂ₐ and L_{2b} are selectively tunable depending on a desired UV light output wavelengths.

The laser lights L₁ₐ, L_{1b}, L₂ₐ and L_{2b} are power-amplified by high power fiber amplifiers. The laser lights L₁ₐ and L_{1b} which are derived from the Q-EDFL 32, are amplified by Ed/Yb-doped fiber amplifiers (EYDFA) 40 and 42, respectively. The laser lights L₂ₐ and L_{2b}, derived from the Q-YDFL 34, are amplified Yb-doped fiber amplifiers (YDFL) 44 and 46, respectively. The amplified fiber lasers L₁ₐ, L_{1b}, L₂ₐ and L_{2b} are frequency-doubled by a group of second-order non-linear crystals, for example, as shown in FIG. 2, Titanium (Ti): PPLN waveguides 48, 50, 52 and 54, which are used to generate second harmonic lights L′₁ₐ, L′_{1b}, L′₂ₐ and L′_{2b}, respectively. FIG. 2 shows the second harmonic lights L′₁ₐ, L′_{1b}, L′₂ₐ and L′_{2b} having doubled-frequencies 2ω₁ₐ, 2ω_{1b} , 2ω₂ₐ and 2ω_{2b} , and wavelengths 765 nm, 785 nm, 530 nm and 550 nm, respectively.

In order to generate desired UV light output wavelengths, the second harmonics are selectively non-linear frequency-mixed with each other. For example, as shown in FIG. 2, the second harmonic lights L′₁ₐ and L′₂ₐ are non-linear sum frequency-mixed by the first WDM coupler 56. The frequency mixed lights L′₁ₐ +L′₂ₐ are focused on the first caesium lithium triborate (CLBO) crystal 64 by using the first graded index (GRIN) lens 60 to generate the first UV light output Uₒᵤₜ₁ having a wavelength of 313 nm. Likewise, the second harmonic lights L′_{1b} and L′₂b are also non-linear sum frequency-mixed by the second WDM coupler 58. The frequency mixed lights L′_{1b}+L′_{2b} are focused on the second CLBO crystal 66 by using the second GRIN lens 62 to generate the second UV light output Uₒᵤₜ₂ having a wavelength of 323 nm. The first and second UV light outputs Uₒᵤₜ₁ and Uₒᵤₜ₂ are combined by using a dichromic mirror 68 and a mirror 70.

Thus, according to the present invention, a UV light generation system is achieved, which is precisely tunable to obtain desired wavelengths by using fiber lasers, a frequency-doubling unit and a non-linear frequency-mixing unit. Also, if necessary, the frequency-doubling unit can be altered to generate third, fourth or even higher-order harmonic lights by simply adding PPLN waveguides. Also, as mentioned above, the present invention provides highly efficient and high power UV light system, which is also rugged, durable and cost-effective for the use in severe operation conditions.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. An ultraviolet (UV) light generator comprising:
a plurality of fiber lasers, each fiber laser generating a laser light, wherein each laser light has a wavelength predetermined based on a desired UV light wavelength;
a frequency-multiplying unit for generating a plurality of harmonic lights by frequency-multiplying each of said plurality of laser lights; and
a non-linear frequency mixer for combining wavelengths of said plurality of harmonic lights to generate a UV light with the desired UV light wavelength.

2. The UV light generator of claim 1, wherein said plurality of fiber lasers comprising at least one Q-switched erbium/ytterbium-doped fiber laser and at least one Q-switched ytterbium-doped fiber laser.

3. The UV light generator of claim 1, said frequency-multiplying unit comprising a plurality of second-order non-linear crystals provided corresponding to the plurality of the fiber lasers, respectively.

4. The UV light generator of claim 3, wherein said plurality of second-order non-linear crystals are plurality of periodically poled LiNbO₂ (PPLN) waveguides or the like.

5. The UV light generator of claim 1, wherein said non-linear frequency mixer comprises a wavelength division multiplexing (WDM) coupler.

6. The UV light generator of claim 1, wherein said plurality of frequency-mixed harmonics are focused on a second-order non-linear crystal by using a focusing optic.

7. The UV light generator of claim 6, wherein said second-order non-linear crystal is a lithium triborate crystal (LBO) or the like.

8. The UV light generator of claim 6, wherein said focusing optics is a graded index (GRIN) lense.

9. The UV light generator of claim 2, wherein said plurality of fiber lasers comprises:
a Q-switched erbium/ytterbium-doped fiber laser generating a first laser light having a first wavelength; and
a Q-switched ytterbium-doped fiber laser generating a second laser light having a second wavelength.

10. The UV light generator of claim 9, wherein said frequency multiplying unit comprising:
a first periodically poled LiNbO₂ (PPLN) waveguide for frequency doubling said first laser light from said Q-switched erbium/ytterbium-doped fiber laser; and
a second periodically poled LiNbO₂ (PPLN) waveguide for frequency doubling said second laser light from said Q-switched ytterbium-doped fiber laser.

11. The UV light generator of claim 10, wherein said frequency multiplying unit further comprising:
at least one additional PPLN waveguide provided between said first PPLN waveguide and said non-linear frequency mixer for generating a third or higher harmonic of said first laser light; and
at least one additional PPLN waveguide provided between said second PPLN waveguide and said non-linear frequency mixer for generating a third or higher harmonic of said second laser light.

12. A ultraviolet (UV) light generator comprising:
a plurality of fiber lasers, each fiber laser generating one or more laser lights, wherein each laser light has a wavelength predetermined based on desired UV light wavelengths;
a frequency-multiplying unit for generating harmonic lights of each laser light; and
a non-linear frequency mixing unit for selectively combining wavelengths of said plurality of harmonic lights to generate one or more UV lights with the desired UV light wavelengths.

13. The UV light generator of claim 12, wherein said plurality of fiber lasers comprising:
a first dual-wave fiber laser generating first and second laser lights; and
a second dual-wave fiber laser generating third and fourth laser lights.

14. The UV light generator of claim 13, wherein said first dual-wave fiber laser is a Q-switched dual-wave erbium/ytterbium-doped fiber laser, and said second dual-wave fiber laser is a Q-switched dual-wave ytterbium-doped fiber laser.

15. The UV light generator of claim 14, further comprising:
a first wavelength division multiplexing (WDM) splitter for separating said first and second laser lights from said Q-switched dual-wave erbium/ytterbium-doped fiber laser;
a second wavelength division multiplexing (WDM) splitter for separating said third and fourth laser lights from said Q-switched dual-wave ytterbium-doped fiber laser; and
a plurality of fiber amplifiers for amplifying said first, second, third and fourth laser lights from said first and second wavelength division multiplexing splitters and transferring said first, second, third and fourth laser lights to said a frequency-doubling unit.

16. The UV light generator of claim 13, wherein said frequency-multiplying unit comprises first, second, third and fourth second-order non-linear crystals for respectively generating second harmonics of said first, second, third and fourth laser lights from said first and second dual-wave fiber lasers.

17. The UV light generator claim 16, wherein said first, second, third and fourth second-order non-linear crystals are periodical poled LiNbO₂ (PPLN) waveguides or the like.

18. The UV light generator of claim 16, wherein said non-linear frequency mixing unit comprises:
a first wavelength division multiplexing (WDM) coupler for combining wavelengths of said second-harmonics of said first and third laser lights; and
a second wavelength division multiplexing (WDM) coupler for combining wavelengths of said second-harmonics of said second and fourth laser lights

19. The UV light generator of claim 18, wherein said frequency-mixed second harmonics of said first and third laser lights are focused on a first second-order non-linear crystal by using a first graded index (GRIN) lense to generate a first UV light with a first desired wavelength, and
said frequency-mixed second harmonics of said second and fourth laser lights are focused on a second second-order non-linear crystal by using a second graded index (GRIN) lense to generate a second UV light with a second desired wavelength.

20. The UV light generator of claim 19, wherein said first and second second-order non-linear crystals are lithium triborate (LBO) crystals.

21. The UV light generator of claim 19, wherein said first and second UV lights are combine by using first and second mirrors, one of said first and second mirrors being a dichromic mirror.

22. A method for generating a ultraviolet (UV) light, comprising the steps of:
generating a plurality of laser lights by using fiber lasers, wherein a wavelength of each laser lights is predetermined based on a desired UV light wavelength;
frequency-multiplying said plurality of laser lights to generate a plurality of harmonic lights of said plurality of laser lights;
non-linear frequency-mixing said plurality of harmonic lights; and
focusing said plurality of frequency-mixed harmonic lights to generate a UV light having the desired UV light wavelength.

23. The method of claim 22, wherein said plurality of laser lights are generated by using at least one erbium/ytterbium-doped fiber laser and at least one ytterbium-doped fiber laser

24. The method of claim 22, wherein each harmonic light is formed by using at least one second-order non-linear crystal.

25. The method of claim 24, wherein the second-order non-linear crystal is a periodical poled LiNbO₂ (PPLN) waveguides or the like.

26. The method of claim 22, wherein said plurality of frequency-mixed harmonics are focused on a second-order non-linear crystal by using a graded index (GRIN) lense to generate a UV light with the desired UV light wavelength.

27. The method of claim 26, wherein the second-order non-linear crystal is a lithium triborate crystal (LBO) or the like.
